(19) United States
(12) Patent Application Publication
(10) Pub. No.: US 2013/0291745 A1
(43) Pub. Date: Nov. 7, 2013

(54) METHOD AND SYSTEM FOR INSTANTANEOUSLY DETERMINING PRINTING FLUID VOLUME CONSUMED IN A PRINTING PRESS

(71) Applicant: GOSS INTERNATIONAL AMERICAS, INC., Durham, NH (US)

(72) Inventors: Michael Raymond Rancourt, Merrimack, NH (US); Brian Robert Elkinson, Barrington, NH (US)

(21) Appl. No.: 13/873,375

(22) Filed: Apr. 30, 2013

Related U.S. Application Data
(60) Provisional application No. 61/640,891, filed on May 1, 2012.

(51) Int. Cl. B41F 31/02

(52) U.S. Cl. CPC B41F 31/022
USPC 101/365

(57) ABSTRACT

A method for calculating an instantaneous total volume of printing fluid used in a printing press is provided. The method includes inputting parameters of a printing fluid dispenser into a controller, calculating an instantaneous total volume of printing fluid consumed by the printing fluid dispenser using the controller and displaying the calculated instantaneous total volume of printing fluid on a human machine interface. A printing press is also provided.

Priority is hereby claimed to U.S. Provisional Patent Application No. 61/640,891 filed on May 1, 2012, the entire disclosure of which is hereby incorporated by reference herein.

The present invention relates generally to printing presses and more specifically to a method and system for instantaneously determining total printing fluid volume consumed in a printing press.

### BACKGROUND

Flow meter devices have been used to measure a total ink flow into a press room, which may include one or multiple printing presses.

Additionally, calculation of ink consumption based on job coverage and known ink weights for given ink film thickness have been accomplished. This approach assumes a uniform ink film thickness throughout the print job and thereby is only an estimate of ink volume.

### SUMMARY OF THE INVENTION

A method for calculating an instantaneous total volume of printing fluid used in a printing press is provided. The method includes inputting parameters of a printing fluid dispenser into a controller, calculating an instantaneous total volume of printing fluid consumed by the printing fluid dispenser and displaying the calculated instantaneous total volume of printing fluid on a human machine interface.

A printing press is also provided. The printing press includes a printing fluid dispenser, a plate cylinder receiving printing fluid from the printing fluid dispenser, a blanket cylinder interacting with the plate cylinder and printing images on a printing substrate, a controller calculating an instantaneous total volume of printing fluid consumed by the printing fluid dispenser and a human machine interface displaying the calculated instantaneous total volume of printing fluid consumed.

### BRIEF DESCRIPTION OF THE DRAWINGS

The present invention is described below by reference to the following drawings, in which:

FIG. 1 shows a printing press including a plurality of printing fluid dispensers according to one embodiment of the present invention;

FIG. 2a schematically shows a plan view and FIG. 2b schematically shows a cross sectional side view of an open fountain unit according to one embodiment of the present invention; and

FIG. 3 schematically shows cross sectional side view of a rail fountain unit according to one embodiment of the present invention.

### DETAILED DESCRIPTION

Embodiments of the present invention may allow for accurate instantaneous calculations of an actual volume of printing fluid, such as ink or dampening solution, consumed in a printing press during a print job. The printing fluid is generally continuously dispensed from printing fluid dispensers to plate cylinders. Calculating the instantaneous actual volume of printing fluid consumed allows a printing press operator to determine the cost of printing fluid consumed in real time.

Each instantaneous calculation may be used to track ink utilization through a print job or multiple print jobs run on one or more printing presses. Knowing the instantaneous total volume of ink consumed permits an operator of the printing press to calculate instantaneous total accumulated print fluid cost for the present point in the print job and/or an instantaneous total accumulated cost for the present point in the print job. The instantaneous total accumulated cost for the present point in the print job is defined herein as being the instantaneous total accumulated cost of the printing fluid consumed for the print job plus instantaneous additional accumulated print job costs for the present point in the print job, which may include the cost of the printing substrate used up until the present instant of the print job, the labor costs and the electricity costs of operating the printing press. Additionally, knowing the instantaneous total volume of the ink consumed permits an operator of the printing press to evaluate different ink formulations and the cost effectiveness of each ink formulation with respect to a number of different printing substrates onto which the ink is being printed.

For example, in one embodiment, before a print job on a substrate is run, a press operator may print two or more short test runs using two or more different ink formulations to determine the cost effectiveness of the two or more ink formulations relative to each other for the substrate. A certain same number of pages may be printed on the substrate with each ink and a controller may calculate the total instantaneous volume of each ink consumed to print the certain number of pages. The controller may then calculate, using the price of each ink per volume, the cost of each ink to print the entire print job. The printing press operator may then determine, based on the print quality and the cost effectiveness, which ink should be used for the print job. In another embodiment, the controller may include a memory that stores data regarding the total amount of ink consumed at numerous time intervals of previous print jobs. For each print job, the memory may include the substrate and ink formulation used and may include the percentage of the printing plates that were imaged to receive ink. The controller, with or without interaction by the printing press operator, may then compare the instantaneous total accumulated costs for the present point in the print job with the data of one or more previous print jobs and evaluate the cost effectiveness of the ink formulation.

Embodiments of the present invention may be applicable to printing fluid dispensers in the form of open fountain inking units and digital rail inking units. For open fountain units, the method may utilize a width of keys in the fountain unit (“key width,” a constant), an opening distance of each key in the fountain unit (“key opening,” a variable), a rotational speed of a fountain roll of the fountain unit (“fountain roll speed,” a variable) and ink returning to the fountain unit (“ink return,” a constant) to calculate the instantaneous total actual volume of printing fluid emitted from the fountain unit onto the printing substrate. For digital rail fountain units, the method may utilize a diameter of the orifices (“orifice diameter,” a constant), a percentage each orifice is open (“orifice opening percent,” a variable) and a speed of at least one pump of the fountain unit (“pump speed,” a variable) to calculate the instantaneous total actual volume of printing fluid emitted from the fountain unit onto the printing substrate.

The calculation of the instantaneous total volume of printing fluid emitted from the printing fluid dispenser onto the printing substrate may be used to display the instantaneous total volume and/or cost to the printing press operator on a human machine interface, such as a computer screen. The operator may then adjust the supply of ink to find an optimal balance between the print quality of the printed products and the costs of the printing fluid.

Ink cost and volume may be configurable printing press parameters that may be set and adjusted by the printing press operator interacting with the controller through one or more human machine interfaces. These configurable parameters may be adjusted before the print job or advantageously during the print job based on the instantaneous volume and/or cost calculations displayed to the printing press operator.

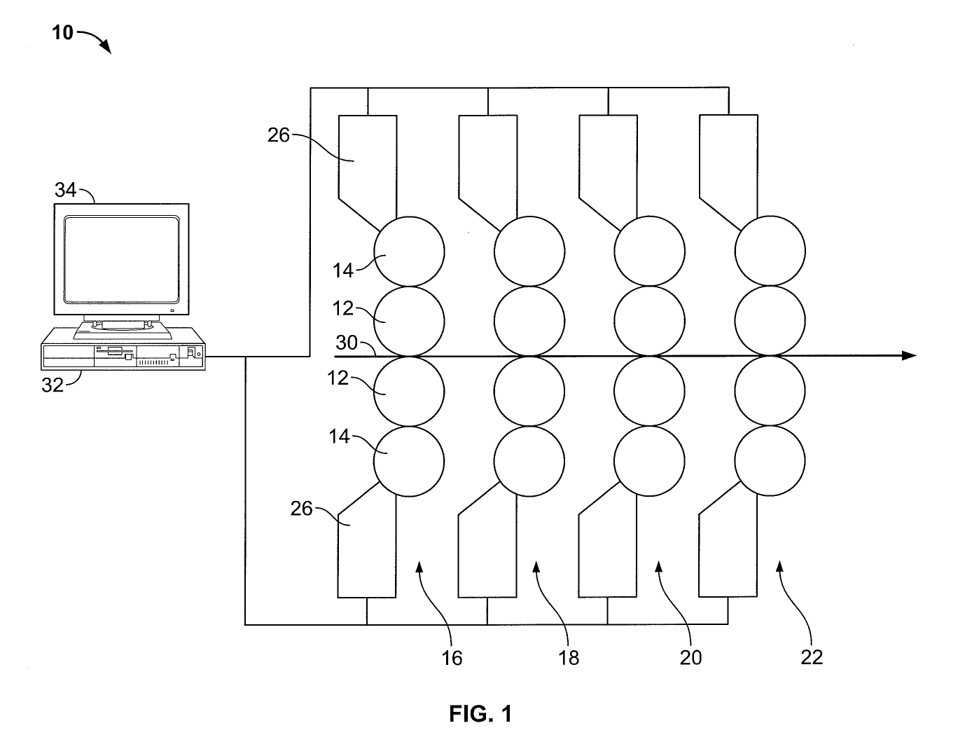

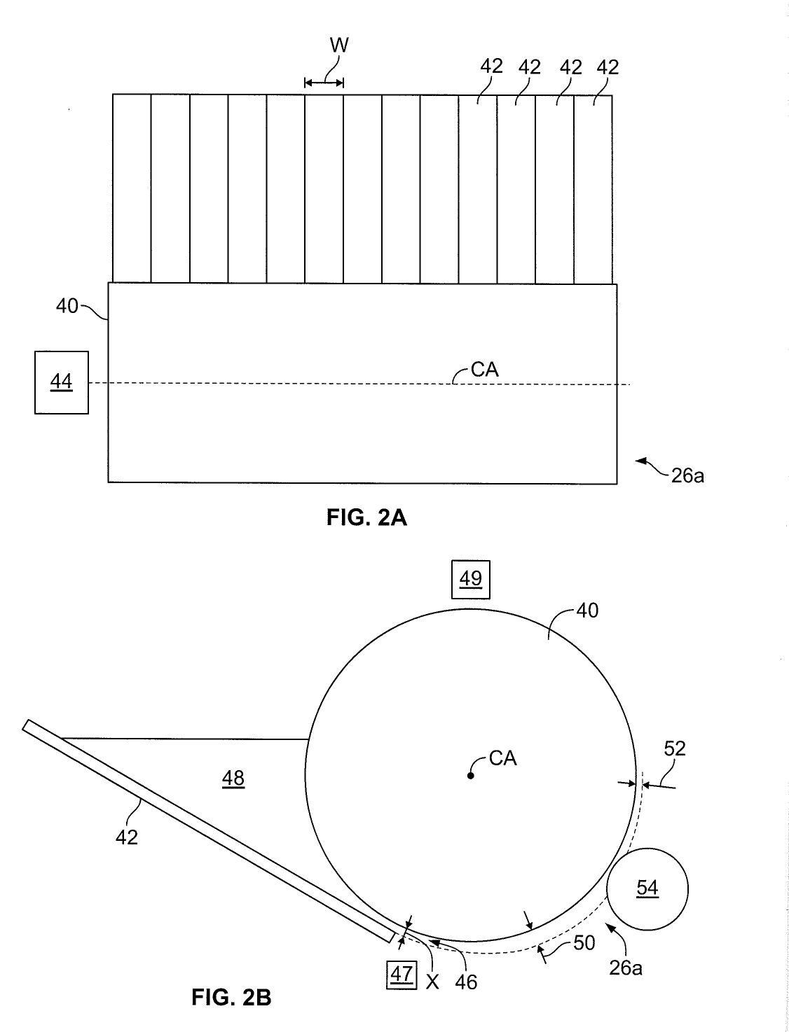

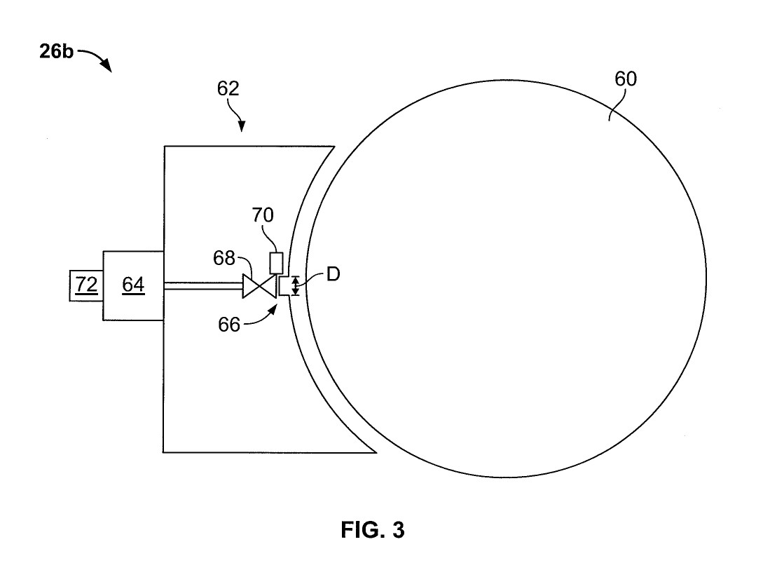

FIG. 1 shows a printing press 10 including a plurality of printing fluid dispensers 26 according to one embodiment of the present invention. In this embodiment, printing press 10 is a perfecting web offset lithographic printing press and includes four printing units 16, 18, 20, 22, each including two plate cylinders 14 and two blanket cylinders 12, printing on a substrate 30, which in this embodiment is a web. In other embodiments, substrate 30 may be in sheet form. Each printing unit 16, 18, 20, 22 prints a different color ink on substrate 30. The four inks printed are cyan, magenta, yellow and black. In other embodiments, printing press 10 may be a nonperfecting printing and/or may have less than or greater than four printing units. Printing fluid dispensers 26 dispense printing fluid to corresponding plate cylinders 14 and may all be controlled by a single controller 32. For example, printing fluid dispensers 26 may be open fountain inking units 26a (FIGS. 2a and 2b) or digital rail inking units 26b (FIG. 3). Controller 32 may calculate the instantaneous total volume of ink consumed by the printing fluid dispensers 26 and transmit the instantaneous total volume of ink consumed to a human machine interface (HMI) 34 that is either in wired or wireless communication with controller 32. The printing press operator may be notified of the instantaneous total actual volume of printing fluid emitted from each or all of fountain units 26 on HMI 34, which in a preferred embodiment is a touch screen. In other embodiments more than one controller and HMI may be used. For example, in one embodiment, a controller and a HMI may be provided for each printing unit 16, 18, 20, 22.

FIG. 2a schematically shows a plan view and FIG. 2b schematically shows a cross sectional side view of an open fountain unit 26a according to one embodiment of the present invention. Open fountain unit 26a includes a plurality of ink keys 42, each of a width W, for supplying printing fluid to a fountain roll 40, which is driven about a center axis CA by a motor 44. Fountain roll 40 may receive ink of a thickness 50 and transfer ink to a pick-up or meter roller 54, which transfers ink to one plate cylinder 14 (FIG. 1) via a train of distributor rollers. Meter roller 54 either is spaced from fountain roll 40 by a preset distance or contacts fountain roll 40. If meter roller 54 is spaced from fountain roll 40, ink of a thickness 52 is returned to ink reservoir 48. Ink is supplied to fountain roll 40 through gaps 46 between fountain roll 40 and ink keys 42 from a reservoir 48. Keys 42 are individually actuatable toward and away from fountain roll 40 at gaps 46 by distances X. This allows keys 42 to be adjusted such that distance X may be set for each ink key 42 as a function of the amount of ink that needs to be supplied to a corresponding ink zone of fountain roll 40.

In embodiments where printing press 10 (FIG. 1) includes open fountain units 26a, controller 32 may track the instantaneous total volume of ink applied by each open fountain unit 26a or instantaneous total volume of ink consumed by all of the open fountain units 26a together. For each open fountain unit 26a, controller 32 may receive inputs concerning the width W of keys 42 (a constant), a surface velocity Vₛ fountain roll 40 is rotated by motor 44, the distances X of each of gaps 46 between ink keys 42 and fountain roll 40 and the thickness 52 of ink returned to ink reservoir 48 (based on a distance between fountain roll 40 and meter roller 54, which may be zero) and calculate at each instant, the total instantaneous total volume of ink that has been output by ink reservoir 48 to fountain roll 40. The ink output or consumed by fountain units 26a is the amount of ink that has passed through gaps 46. Controller 32 may then display the ink consumed in real-time to an operator on HMI 34. Controller 32 may also perform simultaneous additional or alternative real-time calculations. For real-time cost calculations, controller 32 may receive inputs regarding the cost of the ink per a unit of volume (i.e., dollars/ounce) and calculate and display the instantaneous total cost of ink consumed by fountain unit 26a on HMI 34.

A distance sensor 47 may be provided for each ink key 42 to measure the distance X between the respective key 42 and fountain roll 40 and input the distances X into controller 32 (FIG. 1) and a surface velocity sensor 49 may be provided to directly measure the surface velocity Vₛ of fountain roll 40 and input the surface velocity Vₛ into controller 32. Alternatively, the surface velocity Vₛ of fountain roll 40 may be measured indirectly, by using a sensor for measuring the angular velocity fountain roll 40 is rotated by motor 44 and calculating the surface velocity based on a diameter of fountain roll 40. Width W of ink keys 42 may be input into controller 32 by a printing press operator or may be automatically determined by controller 32 upon connection of fountain unit 26a with controller 32. Controller 32 may multiply width W, distance X and surface velocity Vₛ (and when required determine the amount of ink returned to reservoir 48) and continuously update the ink volume consumed at predetermined time intervals to calculate the ink volume consumed in real-time for display on HMI 34.

FIG. 3 schematically shows a cross sectional side view of a rail fountain unit 26b according to one embodiment of the present invention. Rail fountain unit 26b includes an inking rail 62 supplying ink to a fountain roll 60 via a plurality of orifices 66 formed across the length of inking rail 62 and facing fountain roll 60. Each orifice 66 has a diameter D and the percentage of time that diameter D is open for ink to pass through may be controlled individually for each orifice 66 via a respective valve 68. At least one pump 64 may be provided for pumping ink through valves 68 and orifices 66 onto fountain roll 60.

In embodiments where printing press 10 (FIG. 1) includes rail units 26b, controller 32 (FIG. 1) may track the instantaneous total volume of ink applied by each rail unit 26b or instantaneous total volume of ink consumed by all of the rail units 26b together. For each rail unit 26b, controller 32 may receive inputs concerning the diameter D of orifices 66 (constant), the percentage P of time each orifice 66 is open (variable) and a speed Vₚ the at least one pump 64 supplies ink to rail 62 (variable) and continuously calculate the total volume of ink that has been output by rail 62 to fountain roll 60. The ink output or consumed by fountain units 26b is the amount of ink that has passed through orifices 66. Controller 32 may then display the ink consumed in real-time to an operator on HMI 34. Controller 32 may also perform simultaneous additional or alternative real-time calculations. Along these lines, controller 32 may receive inputs regarding the cost of the ink per a unit of volume (i.e., dollars/ounce) and calculate and display the real-time total cost of ink consumed by rail unit 26b on HMI 34.

A opening sensor 70 may be provided for each valve 68 to measure percentage P of time each orifice 66 is open and input the percentages P into controller 32 (FIG. 1) and a pump speed sensor 72 may be provided to measure the speed Vₚ the at least one pump 64 supplies ink to rail 62 and input the pump speed Vₚ into controller 32. Percentage P of time that orifices 66 are open may be input into controller 32 by a printing press operator or may be automatically determined by controller 32 upon connection of rail unit 26b with controller 32. Controller 32 may multiply diameter D, percentage P and pump speed Vₚ and continuously update the ink volume consumed at predetermined time intervals to calculated the ink volume consumed by rail unit 26b in real-time for display on HMI 34.

Additionally, controller 32 may receive inputs regarding the amount of substrate printed (e.g., pages printed or a length of substrate printed) and may calculate the volume of ink consumed per unit of substrate. Controller 32 may also receive inputs regarding the amount of substrate that is going to be printed for the entire print job and calculate the expected cost for the entire print job based on the volume of ink consumed per unit of substrate. The additional calculations may then be displayed on HMI 34 for viewing by the printing press operator.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A method for calculating an instantaneous total volume of printing fluid used in a printing press comprising:
inputting parameters of a printing fluid dispenser into a controller;
calculating an instantaneous total volume of printing fluid consumed by the printing fluid dispenser using the controller; and
displaying the calculated instantaneous total volume of printing fluid on a human machine interface.

2. The method as recited in claim 1 wherein the printing fluid dispenser is an open fountain inking unit and the instantaneous total volume of printing fluid consumed by the printing fluid dispenser is calculated as a function of a width of ink keys of the open fountain inking unit, distances between the ink keys and a fountain roll of the open fountain inking unit, and a surface velocity of the fountain roll.

3. The method as recited in claim 1 wherein the printing fluid dispenser is a rail inking unit and the instantaneous total volume of printing fluid consumed by the printing fluid dispenser is calculated as a function of a diameter of orifices of an ink rail, a percentage of time each orifice is open, and a speed at least one pump supplies ink to the ink rail.

4. The method as recited in claim 1 further comprising inputting a cost of the printing fluid per a unit of volume; calculating the instantaneous total cost of printing fluid consumed by the printing fluid dispenser for a print job; and displaying the instantaneous total cost of printing fluid consumed by the printing fluid dispenser on the human machine interface.

5. The method as recited in claim 4 further comprising adjusting at least one variable parameter used to calculate the instantaneous total volume of printing fluid consumed by the printing fluid dispenser to achieve an optimal balance between print quality and an estimated total cost of the print job.

6. The method as recited in claim 4 further comprising comparing the instantaneous total cost of printing fluid consumed by the printing fluid dispenser for printing fluid being used with previous calculation of an instantaneous total cost of a different printing fluid consumed by the printing fluid dispenser for the same print job at a same point in the print job.

7. The method as recited in claim 6 further comprising comparing the instantaneous total cost of the printing fluid with the data of one or more previous print jobs and evaluating the cost effectiveness of the printing fluid.

8. The method as recited in claim 6 further comprising inputting instantaneous additional accumulated print job costs for a present point in the print job; calculating an instantaneous total accumulated costs for a present point in the print job and displaying the instantaneous total accumulated print job costs for the present point in the print job on the human machine interface.

9. The methods as recited in claim 1 wherein the instantaneous total volume of printing fluid consumed by the printing fluid dispenser is calculated as a function of at least one constant parameter and at least one variable parameter.

10. A printing press comprising:
a printing fluid dispenser;
a plate cylinder receiving printing fluid from the printing fluid dispenser;
a blanket cylinder interacting with the plate cylinder and printing images on a printing substrate;
a controller calculating an instantaneous total volume of printing fluid consumed by the printing fluid dispenser; and
a human machine interface displaying the calculated instantaneous total volume of printing fluid consumed.

11. The printing press as recited in claim 10 wherein the printing fluid dispenser is an open fountain inking unit.

12. The printing press as recited in claim 11 wherein the open fountain inking unit includes a plurality of ink keys and a fountain roll receiving ink through a gap between the ink keys and the fountain roll, the controller calculating the instantaneous total volume of printing fluid consumed by the printing fluid dispenser as a function of a width of the ink key, distances between each of the ink keys and the fountain roll and a surface velocity of the fountain roll.

13. The printing press as recited in claim 10 wherein the printing fluid dispenser is a rail inking unit.

14. The printing press as recited in claim 13 wherein the rail inking unit includes an ink rail including a plurality of orifices and at least one pump supplying printing fluid to the ink rail, the controller calculating the instantaneous total volume of printing fluid consumed by the printing fluid dispenser as a function of a diameter of the orifices, a percentage of time each orifice is open and a speed the at least one pump supplies ink to the ink rail.

15. The printing press as recited in claim 10 wherein the controller receives inputs of a cost of the printing fluid per a unit of volume and calculates the instantaneous total cost of printing fluid consumed by the printing fluid dispenser, the human machine interface displaying the instantaneous total cost of printing fluid consumed by the printing fluid dispenser.

16. The printing press as recited in claim 15 wherein the controller receives inputs of instantaneous additional accumulated print job costs for a present point in the print job and calculates an instantaneous total accumulated costs for a present point in the print job, the human machine interface displaying the instantaneous total accumulated costs for the present point in the print job.
